(19) United States
(12) Patent Application Publication
(10) Pub. No.: US 2008/0118323 A1
(43) Pub. Date: May 22, 2008

(54) METHOD AND APPARATUS FOR MACHINING WORK BY CUTTING TOOL

(75) Inventor: Shozo Suzuki, Mishima-shi (JP)

Correspondence Address: DLA PIPER US LLP, P. O. BOX 9271, RESTON, VA, 20195, US

(73) Assignee: TOSHIBA KIKAI KABUSHIKI KAISHA, CHIYODA-KU (JP)

(21) Appl. No.: 11/941,454

(22) Filed: Nov. 16, 2007

(30) Foreign Application Priority Data
Nov. 17, 2006 (JP) 2006-310880
Nov. 17, 2006 (JP) 2006-310906
Nov. 17, 2006 (JP) 2006-310912

(51) Int. Cl. B23D 1/00

(52) U.S. Cl. 409/293; 409/319; 409/346

(57) ABSTRACT

In the machine tool according to the present invention, a cutting tool 25 is configured to be optionally turned to take each reverse orientation, based on a C axis as the center of rotation about the Z axis, which is vertical to the X-Y plane parallel to a top face of a work 13. First, the orientation of the cutting tool 25 is set to correspond to machining in an advancing stroke for the work 13, so as to perform the machining for the work while moving it in an advancing direction. Then, the orientation of the cutting tool is reversed, so as to perform the machining for the work while moving it in a retracting direction.

### BACKGROUND OF THE INVENTION

1. Field of the Invention

The present invention relates to a method and a apparatus for forming multiple fine grooves or the like in a surface of a work, by reciprocating a work requiring fine machining, on an X-Y plane, relative to a cutting tool or cutting tool, for example, in a planer type machining tool. In particular, this invention relates to a method and a apparatus, which can enhance efficiency of machining an article requiring a fine structure, such as a mold for a light-guide plate, a polarizing plate and a diffusion plate for use in, for example, liquid crystal display devices, plasma display devices and other thin type display devices.

2. Background Art

Machining of such an article having a fine structure as described above, for example, a mold for producing optical instruments will be discussed below. Typically, such a mold has multiple grooves. In order to form such a fine structure, a cutting tool is usually used, and the machining is performed, by reciprocating a work, a material to be used for forming the mold, on an X-Y plane, relative to the cutting tool (e.g., see Japanese Laid Open No. 2005-279918).

In the machining performed by reciprocating the work on the X-Y plane relative to the cutting tool as described above, a planer type machining tool is typically used. The planer type machining tool is configured to reciprocate the work in the X direction, for example, on the X-Y plane. During the machining, the cutting tool is kept to take a position oriented along the Z direction vertical to the X-Y plane. While the cutting tool is not moved in the X direction, it is moved in the Y direction for each reciprocating movement of the work.

The cutting tool has a rake angle, a clearance angle, and an orientation suitable for the machining. Thus, in the past, the cutting tool machined the work only in one of advancing and retracting directions during the reciprocating movement of the work. For the mold described above, it is necessary to form a great number of fine grooves therein. Therefore, the number of the reciprocating movements of the work should be significantly large, thus requiring a quite long time to machine the work.

In recent years, thin type display panels, such as large size liquid crystal panels, have appeared, and the tendency to increase the size has become more conspicuous. With such a tendency, the mold for use in producing the light-guide plates and shielding sheets used for the liquid crystal panels has also been enlarged, for example, into a size with a side of from about 300 mm to 800 mm, and even up to 1500 mm. In the case of machining such a mold, it sometimes should take 1 to 2 weeks to complete the machining for one mold.

In order to reduce the machining time for producing the mold, it would be preferable to enable machining in both of the advancing and retracting directions, rather than machining in only one direction. To this end, it is necessary to change the cutting direction or orientation of the cutting tool. However, due to the change of the orientation of the cutting tool, for example, when the cutting edge of the cutting tool is moved in the Y axis direction, the position of the cutting edge will be shifted from a predetermined position, for each reciprocating movement of the work, thus making it difficult to perform desired machining.

Also in the case of performing a cutting operation so as to make a predetermined curve while changing the orientation of the cutting tool during the advancing or retracting stroke, a positional shift to be caused due to such a change of the orientation of the cutting tool would make it difficult to form the predetermined curve.

It is an object of the present invention to enhance efficiency of machining a surface of a work by reciprocating the work on the X-Y plane relative to the cutting tool.

It is another object of the present invention to provide an apparatus, which can perform machining the surface of the work as well as forming a curve in the work surface, appropriately, in both of the advancing and retracting strokes, while holding the cutting edge in a predetermined position, even through changing the cutting direction of the cutting tool.

### SUMMARY OF THE INVENTION

To achieve the above object, a method according to a first aspect of the present invention, which is for machining a surface of a work with a cutting tool, by utilizing an reciprocating movement consisting of an advancing stroke for relative movement in one direction and a retracting stroke for relative movement in the reverse direction to the advancing stroke, in the same plane, between the cutting tool and the work, comprises the steps of: providing a machining tool including a main shaft having an axis vertical to the plane, as a center of rotation, and attaching the cutting tool to the spindle; setting the orientation of a cutting edge of the cutting tool in a direction that enables the work to be machined in an advancing stroke, in which the work is advanced relative to the cutting tool; machining the work, in the advancing stroke, by using the cutting tool; turning the cutting tool reversely, by 180°, upon completion of the advancing stroke, so as to set the orientation of the cutting edge of the cutting tool in a direction that enables the work to be machined in a retracting stroke, in which the work is retracted relative to the cutting tool; shifting the cutting tool in a direction vertical to the reciprocating directions of the work so as to locate the cutting tool in a next machining position; and machining the work by using the cutting tool in the retracting stroke.

The method according to a second aspect of the present invention, which is for machining a surface of a work with a cutting tool, by utilizing an reciprocating movement consisting of an advancing stroke for relative movement in one direction and a retracting stroke for relative movement in the reverse direction to the advancing stroke, in the same plane, between the cutting tool and the work, comprises the steps of: providing a machining tool having an index head, the index head including a rotation shaft having an axis parallel to the plane, as a center of rotation and adapted to index at least two cutting tools, one after another, by utilizing the rotation of the rotation shaft, and attaching the at least two cutting tools to the index head, the at least two cutting tools being in a relation to have reverse directions, to one another, for cutting operation, so that the work can be machined in both of the advancing and retracting strokes for the work; indexing one cutting tool of the plurality of cutting tools to take a machining position by utilizing the rotation of the rotation shaft, so as to cause a cutting edge of the one cutting tool to be oriented in a direction that enables the work to be machined in an advancing stroke, in which the work is advanced relative to the one cutting tool; machining the surface of the work, in the advancing stroke, by using the one cutting tool having been indexed in the machining position; indexing the other cutting tool to take a machining position by utilizing the rotation of the rotation shaft, upon completion of the advancing stroke, so as to cause a cutting edge of the other cutting tool to be oriented in a direction that enables the work to be machined in a retracting stroke, in which the work is retracted relative to the other cutting tool; shifting the other cutting tool in a direction vertical to the reciprocating directions of the work so as to locate the other cutting tool in a next machining position; and machining the surface of the work, in the retracting stroke, by using the other cutting tool having been indexed in the next machining position.

The invention related to an apparatus for carrying out the method according to the first aspect of the present invention is a apparatus for machining a surface of a work, while reciprocating the work on a plane relative to a cutting tool, the apparatus comprising: a bed; a work table, which is located on the bed, configured to be optionally moved, on a horizontal plane, in one direction (X axis), and adapted for placing the work thereon; a pair of columns positioned on both of the left and right sides of the bed; a cross rail provided across the columns; a saddle, which is mounted on the cross rail, and configured to be optionally moved, on the horizontal plane, in a direction (Y axis) vertical to the transfer direction of the work table; a lifting table, which is mounted on the saddle, and configured to be optionally moved in the upward and downward directions (Z axis); and a cutting tool turn table, which is attached to the lifting table, and includes a C axis adapted for turning a cutting edge of the cutting tool about the Z axis to reverse the orientation of the cutting edge, while holding the cutting tool.

The cutting tool turn table of the apparatus includes: a spindle extending in parallel to the Z axis and configured to be turned based on the C axis as a control axis; a servomotor adapted to turn the rotation shaft; a cutting tool holder attached to a distal end of the rotation shaft and adapted to hold the cutting tool; and a center adjusting means provided between the cutting tool holder and the rotation shaft and adapted to adjust a distal end of the cutting edge of the cutting tool to be positioned on the axis of the spindle.

The invention related to an apparatus for carrying out the method according to the second aspect of the present invention is an apparatus for machining a surface of a work, while reciprocating the work on a plane relative to a cutting tool, the apparatus comprising: a bed; a work table, which is located on the bed, configured to be optionally moved, on a horizontal plane, in one direction (X axis), and adapted for placing the work thereon; a pair of columns positioned on both of the left and right sides of the bed; a cross rail provided across the columns; a saddle, which is mounted on the cross rail, and configured to be optionally moved, on the horizontal plane, in a direction (Y axis) vertical to the transfer direction of the work table; a lifting table, which is mounted on the saddle, and configured to be optionally moved in the upward and downward directions (Z axis); and a cutting tool indexing table attached to the lifting table and adapted to hold at least two cutting tools, the at least two cutting tools being in a relation to have reverse directions for cutting, wherein the cutting tool indexing table includes an A axis adapted to index two cutting tools, one after another, such that the work can be machined in both of advancing and retracting strokes for the work.

According to the first aspect of the present invention, by turning the cutting edge of the cutting tool to alternately take reverse orientations, the cutting method can correspond to both of the advancing and retracting strokes. Thus, the work can be machined in both of the advancing and retracting operations. Therefore, the machining time can be reduced approximately by half.

The positioning of the distal end of the cutting edge of the cutting tool on the axial center of the C axis can provide an advantage that the position of the distal end of the cutting tool will not unduly shift even in the case of turning the cutting tool to a revere orientation. Even though there would be an event that some shift occurs between the axial center of the distal end of the cutting tool and the axial center of the C axis, the cutting tool position can be corrected, corresponding to an amount of the shift, when the cutting tool is turned to the reverse orientation. Thus, the positional shift of the cutting tool can be controlled appropriately.

The work is a mold for molding parts each having a fine structure. The present invention can provide a significantly great advantage in such cutting tool-based machining that requires a large number of reciprocating movements, as with the case in which a great number of grooves should be formed by using the cutting tool. With the distal end of the cutting edge of the cutting tool being of a substantially V-shape corresponding to each groove to be formed and with an apex of the V-shape being positioned on the axial center of the C axis, the apex of the cutting tool will not be shifted even when the cutting tool is turned to have a reverse orientation.

Since the center adjusting means is provided between the cutting tool holder and the rotation shaft as well as the cutting edge of the cutting tool is positioned on the axial center of the rotation shaft, the cutting edge can be kept to be always on the axial center of the rotation shaft even when the cutting direction of the cutting tool is changed. Therefore, the machining in both of the advancing and retraction strokes as described above as well as curved-line machining can be performed appropriately, only by controlling the position of the rotation shaft.

According to the second aspect of the present invention, at least two cutting tools, being in a relation to have reverse cutting directions for corresponding to both of the advancing and retracting strokes for the work, are attached to the machine tool, such that the cutting tools can be indexed to take each machining position, one after another, due to the actuation of the A axis. Thus, this invention can correspond to the cutting operation in both of the advancing and retracting strokes for the work. Accordingly, the work can be machined in both of the advancing and retracting operations, as such reducing the machining time approximately by half.

### BRIEF DESCRIPTION OF THE DRAWINGS

FIG. 1 is a front view schematically showing a planer type machining tool to which the first aspect of the present invention is applied.

FIG. 2 is a right side view of the planer type machining tool shown in FIG. 1.

FIG. 3 is a partially enlarged cross section taken along line A-A of FIG. 2.

FIG. 4 is a partially enlarged cross section taken along line B-B of FIG. 3.

FIG. 5 is an enlarged side view of a key portion for illustrating a machining method according to the first aspect of the present invention, in which FIG. 5(A) shows a state just prior to machining to be performed in the advancing stroke, and FIG. 5(B) shows a state just prior to machining to be performed in the retracting stroke.

FIG. 6(A) is a front view when the key portion shown in FIG. 5(A) is seen from the left side, and FIG. 6(B) is a front view when the key portion shown in FIG. 5(B) is seen from the left side.

FIG. 7 is a partially enlarged cross section of a cutting tool turn table according to another embodiment of the first aspect of the present invention.

FIG. 8 is a partially enlarged cross section taken along line B-B of FIG. 7.

FIG. 9 is an enlarged side view of a key portion for illustrating a machining method utilizing the cutting tool turn table shown in FIG. 7, in which FIG. 9(A) shows a state just prior to machining to be performed in the advancing stroke, and FIG. 9(B) shows a state just prior to machining to be performed in the retracting stroke.

FIG. 10(A) is a front view when the key portion shown in FIG. 9(A) is seen from the left side, and FIG. 10(B) is a front view when the key portion shown in FIG. 9(B) is seen from the left side.

FIG. 11 is a front view schematically showing a planer type machining tool to which the second aspect of the present invention is applied.

FIG. 12 is a right side view of the planer type machining tool shown in FIG. 11.

FIG. 13 is a partially enlarged cross section taken along line A-A of FIG. 12.

FIG. 14 is a partially enlarged cross section taken along line B-B of FIG. 13.

FIG. 15 is an enlarged side view of a key portion for illustrating a machining method according to the second aspect of the present invention, in which FIG. 15(A) shows a state just prior to machining to be performed in the advancing stroke, and FIG. 15(B) shows a state just prior to machining to be performed in the retracting stroke.

FIG. 16(A) is a front view when the key portion shown in FIG. 15(A) is seen from the left side, and FIG. 16(B) is a front view when the key portion shown in FIG. 15(B) is seen from the left side.

### DETAILED DESCRIPTION OF THE INVENTION

### Examples

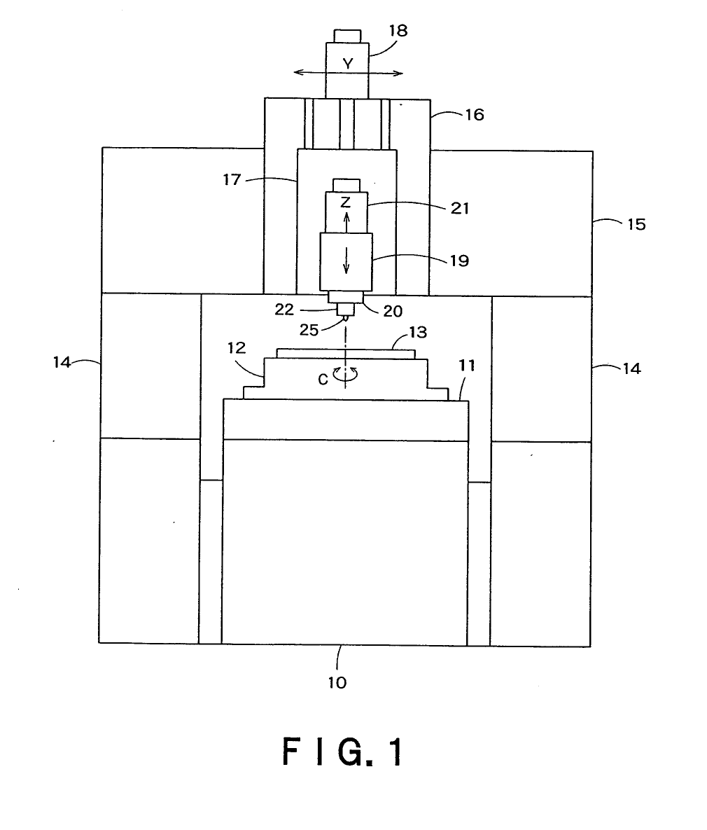

Hereinafter, a preferred embodiment of the present invention will be described with reference to FIGS. 1 to 6.

### First Embodiment

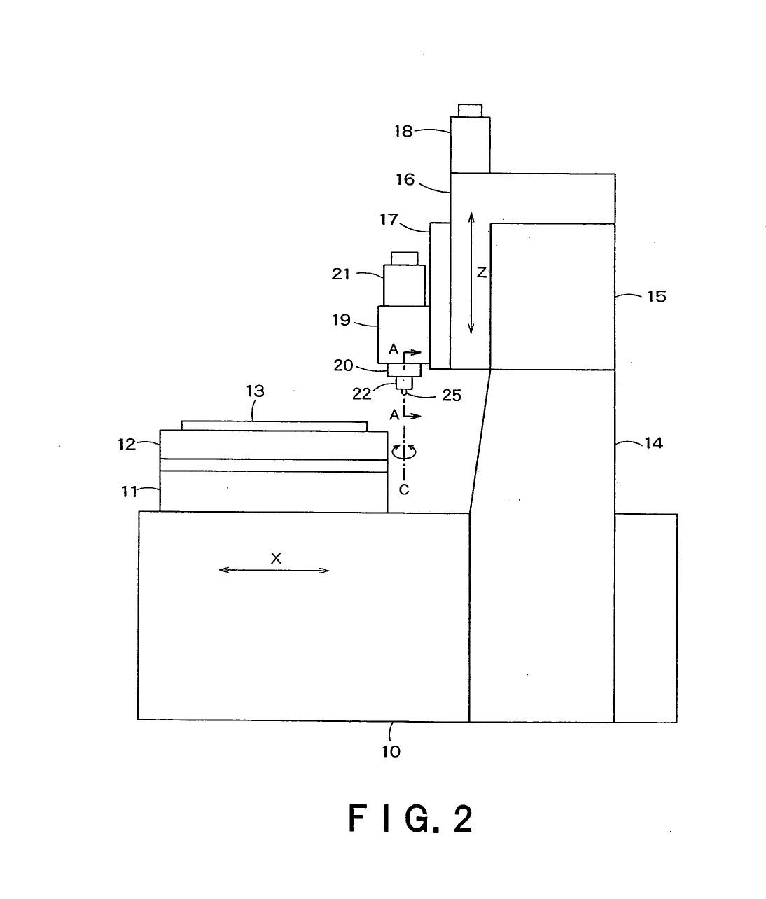

FIG. 1 is a front view schematically showing a first embodiment in which the present invention is applied to a planer type machining tool, and FIG. 2 is a right side view of the tool shown in FIG. 1.

In FIGS. 1 and 2, reference numeral 10 designates a bed, and 11 is a table. The table 11 is driven by a driving apparatus (not shown), such as a linear motor or the like, and is configured to move in a direction vertical to the paper of FIG. 1. The axis for controlling the movement of the table 11 is designated herein as an X axis. The table 11 is mounted on the bed 10. In FIG. 2, the table 11 can be moved, at a predetermined speed, within a predetermined transfer range, parallel to a top face of the table 11, in both of the left and right directions (X axial direction). On the table 11, a vacuum chuck 12 is attached so as to suck and hold a flat work 13.

In FIG. 1, columns 14, 14 extend upward on both sides of the bed 10. A cross rail 15 extending in parallel to the top face of the table 11 is provided across top ends of both columns 14, 14, extending in the left and right directions (Y axial direction) in FIG. 1, while in the vertical direction to the paper of FIG. 2. On the cross rail 15, a saddle 16 is mounted to be optionally moved in both of upward and downward directions. The saddle 16 is driven by a driving apparatus (not shown), such as a linear motor or the like, and can be stopped at any position on the Y axis, based on the Y axis as a control axis.

As shown in FIGS. 1 and 2, a lifting table 17 is mounted to the saddle 16, such that the lifting table 17 can be moved in both of the upward and downward directions, i.e., in the vertical direction (Z axial direction) relative to the top face of the table 11 (the X-Y plane). The lifting table 17 is driven to be raised and lowered by a servomotor 18 attached to the saddle 16 or by another suitable driving apparatus, such as a linear motor or the like, as with the table 11 and saddle 16. The Z axis serves to control the movement of the lifting table 17, and the lifting table 17 can be stopped at any position on the Z axis.

A cutting tool turn table 19 is attached to the lifting table 17. To the cutting tool turn table 19, a spindle (C axis) 20 extending in parallel to the Z axis is rotatably attached. The spindle 20 is given a 180° rotation, as will be described below, by a servomotor 21 attached to the cutting tool turn table 19. The C axis serves to control the turning movement of the spindle 20.

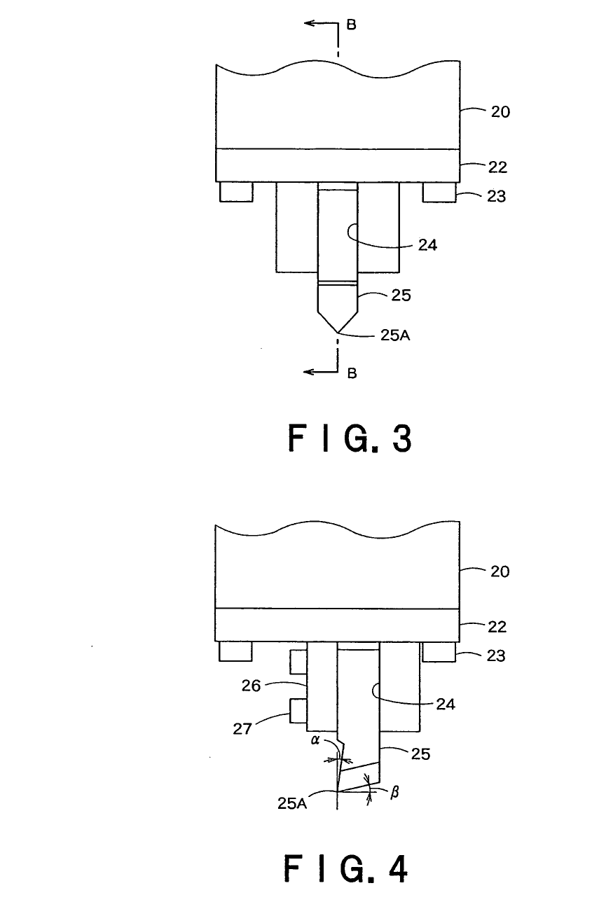

At a distal end of the spindle 20, as depicted in enlarged cross sections of FIGS. 3 and 4, a cutting tool holder 22 is fixed by bolts 23. The cutting tool holder 22 has a groove 24 extending in the vertical direction, in which a cutting tool 25 is fitted. The cutting tool 25 is fixed between a pressing plate 26 and the cutting tool holder 22 by using bolts 27.

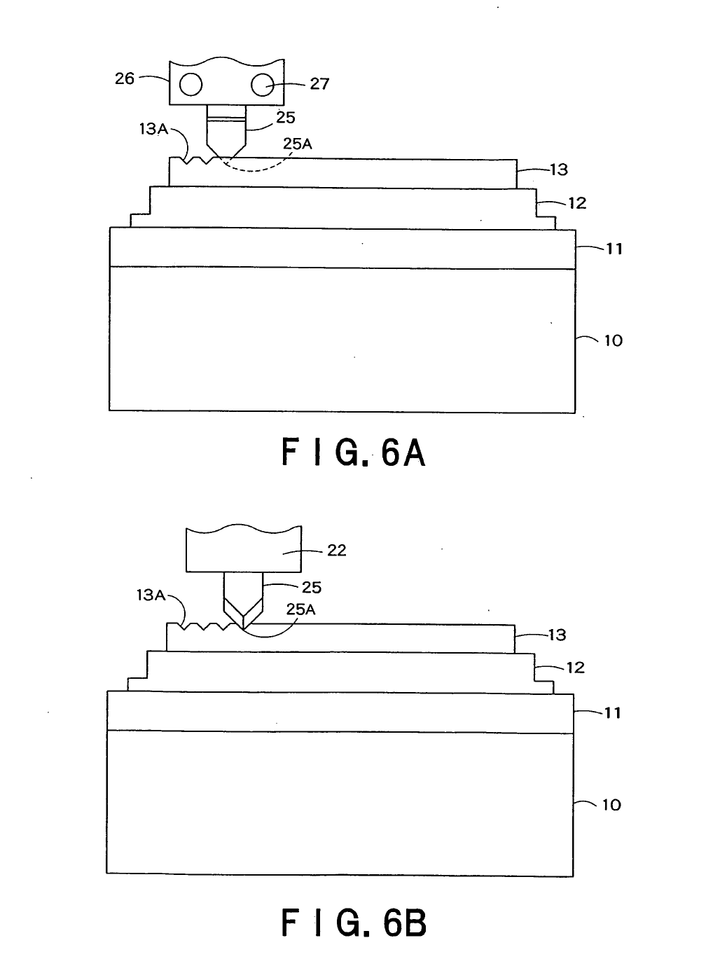

The cutting tool 25, as shown in a front view of FIG. 3, has a cutting edge provided at its distal end. The cutting edge is of a substantially V-shape corresponding to a shape of each fine groove 13A to be formed in a work by the blade, as shown in FIGS. 6(A) and 6(B). The cutting tool 25 is attached to the cutting tool holder 22 such that an apex 25A of the cutting edge is positioned on the axial center of the spindle 20, as shown in FIGS. 3 and 4. The cutting tool 25, as shown in FIG. 4, has the rake angle α (in some cases, this angle is a negative value or zero) and the clearance angle β. Preferably, a diamond cutting tool is used for the cutting tool 25. When the cutting edge of the cutting tool 25 is oriented in a direction as shown in FIG. 4, the cutting tool 25 can provide a cutting process to the work by moving the work from right to left in the drawing, while the cutting tool 25 can not perform the cutting process for the work if the work is moved from left to right.

Next, operation of a machine tool according to the first embodiment and a cutting method of this invention will be described.

First, referring to FIGS. 1 and 2, the position in the Z axial direction of the cutting tool 25 is adjusted to match the depth of each fine groove 13A to be formed. This is for setting a cutting amount of the cutting tool 25. In this case, by moving the lifting table 17 due to the servomotor 18, the level corresponding to the cutting amount of the cutting tool 25 is determined. Thereafter, the position in the Y axial direction of the saddle 16 is adjusted or controlled by the driving apparatus (not shown), such that the cutting tool 25 is located to match a machining position of the fine groove 13A to be formed first.

Subsequently, the table 11 is reciprocated, in the X axial direction, at a predetermined feed speed suitable for the cutting due to the cutting tool 25, so as to perform the cutting process.

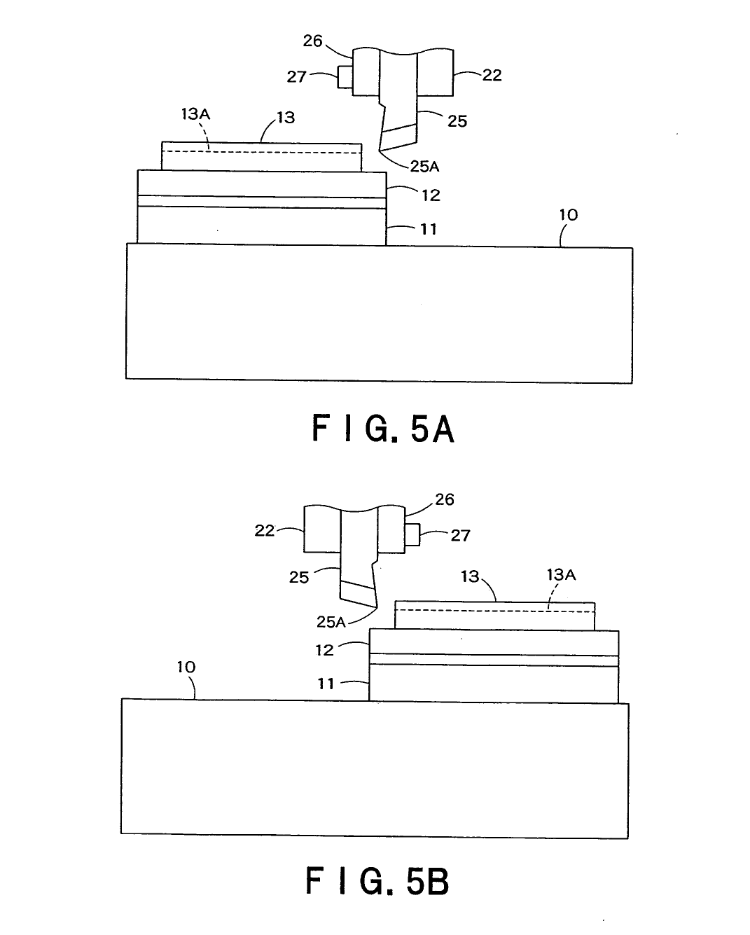

A stroke, in which the table 11 is moved from a left end position of the bed 10 as shown in FIG. 5(A) to a right end position of the bed 10 as shown in FIG. 5(B), is defined herein as an advancing stroke. On the other hand, a stroke, in which the table 11 is moved from the right end position of the bed 10 to the left end position of the bed 10 shown in FIG. 5(A), is defined as a retracting stroke.

Upon the advancing stroke, the cutting tool 25 is set such that the cutting edge will face left as shown in FIG. 5(A). With the so-set cutting tool 25, the fine groove 13A is formed in the surface of the work 13 which is moved left to right in FIG. 5(A). FIG. 6(A) is a front view when a key portion shown in FIG. 5(A) is seen from the left side. To clearly express the shape of each formed groove 13A, FIG. 6(A) shows a state just prior to start of machining in a second advancing stroke, rather than in a first advancing stroke.

Once the work 13 reaches a right end of the bed 10, as shown in FIG. 5(B), the cutting process in the advancing stroke is ended. When the work 13 is spaced, rightward, away from the cutting tool 25, as shown in FIG. 5(B), the saddle 16 is moved in the Y axial direction along the cross rail 15. Namely, as shown in FIG. 6(B), the cutting tool 25 is shifted, rightward, in the drawing, by a distance corresponding to one pitch of each groove 13A previously formed.

At the same time the cutting tool 25 is moved in the Y axial direction, the spindle 20 is driven to be turned 180° by the servomotor 21 of the C axis. Consequently, as shown in FIGS. 5(B) and 6(B), the cutting edge of the cutting tool 25 takes a reversely rotated position. At this time, the cutting tool 25 is only turned, with its position in the Z axial direction being not shifted. Therefore, the level of the apex 25A of the cutting edge is not changed but maintained constant. Since the apex 25A is positioned on the axial center of the spindle 20, as shown in FIGS. 3 and 4, there is no positional shift associated with the turning of the cutting tool 25 to the reverse orientation, also in the Y axial direction of the apex 25A. Accordingly, the cutting edge of the cutting tool 25 can be located accurately in a machining position for forming a next groove, i.e., a next machining position that the cutting edge will reach after being moved by one pitch in the Y axial direction.

If some undue positional shift would occur between the apex 25A and the spindle 20, an undesired positional shift of the apex 25A of the cutting tool 25 in the Y axial direction would also occur due to the aforementioned turning to the reverse orientation. To address this problem, the shifting amount to be associated with the turning to the reverse orientation should be measured in advance, so as to correct the transfer amount of the saddle 16 in the Y axial direction when the cutting tool 25 is moved to a next machining position, corresponding to the shifting amount. In this way, the apex 25A of the cutting tool 25 can be moved accurately by one pitch of each groove 13A.

After the turning to the reverse orientation of the cutting edge of the cutting tool 25 as described above, the table 11 is moved from the right end position of the bed 10 as shown in FIG. 5(B) to the left end position of the bed 10 as shown in FIG. 5(A). During this retracting stroke, the cutting process is provided to create the next groove 13A.

Once the cutting process is ended through the above retracting stroke, the orientation of the cutting edge of the cutting tool 25 is again reversed to take the position shown in FIG. 5(A), so as to perform a next advancing stroke. In this manner, the same retracting and advancing strokes for machining the work will be repeated successively.

As described above, due to the turning to the reverse orientation of the cutting tool 25, the work can be processed in both of the advancing and retracting strokes, as such reducing the machining time approximately by half.

In the above first embodiment, one example, in which the work 13 is reciprocated relative to the cutting tool 25 by utilizing the planer type machining tool, has been described. This invention, however, is not limited to this aspect. For instance, the work 13 may be fixed while the cutting tool 25 may be reciprocated. Additionally, the application of this invention is not limited to the mold for producing parts each having a fine structure, such as light guide plates and shielding sheets to be used for liquid crystal panels, but may also be applied to machining other various types of works. Furthermore, the shape to be formed by the aforementioned machining method is not limited to the groove, but may also be a flat face to be obtained by machining which employs a flat cutting tool. Namely, it should be appreciated that various modifications not described and illustrated herein can also be made without departing from the scope of this invention.

### Second Embodiment

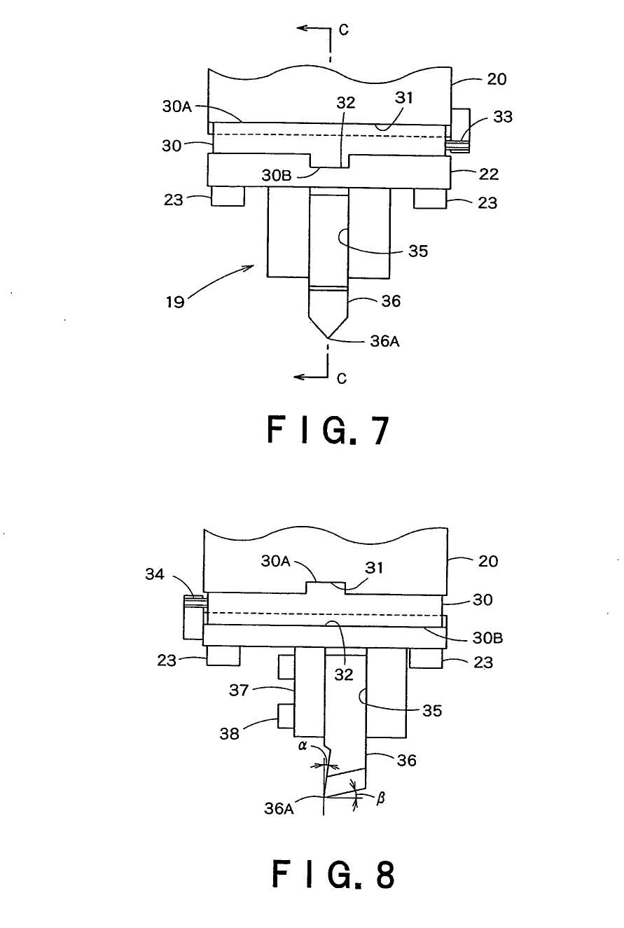

Next, a second embodiment of the present invention will be described with reference to FIGS. 7 to 10. It should be noted that the construction of a main body of the planer type machining tool to which this invention is applied is similar to that of the first embodiment shown in FIG. 1. Therefore, like parts will be designated by like reference numerals and will not be further detailed below.

The second embodiment has a further feature that a center adjusting means is added to the cutting tool turn table 19.

At the distal end of the spindle 20, as shown in FIGS. 7 and 8, the cutting tool holder 22 is fixed by the bolts 23 via a cross joint 30 as the center adjusting means. The cross joint 30 includes projections 30A, 30B respectively extending along and between an upper and a lower end face in an orthogonal relation to each other. Specifically, the projections 30A, 30B are slidably engaged with grooves 31, 32 respectively provided in the distal end face of the spindle 20 and the rear end face of the cutting tool holder 22. To the spindle 20 and cutting tool holder 22, adjusting screws 33, 34 are provided, such that these screws are arranged in parallel to the projections 30A, 30B, while being externally contacted with the outer circumferential face of the cross joint 30, respectively.

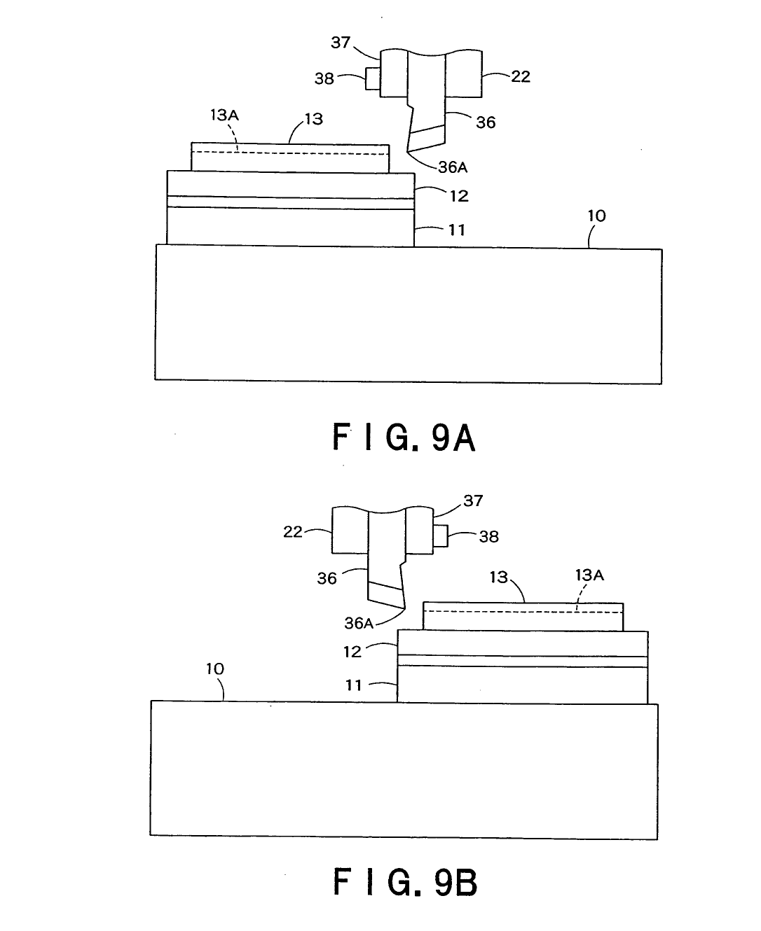

The cutting tool holder 22 has a groove 35 extending in the vertical direction, in which a cutting tool 36 is fitted. The cutting tool 36 is fixed, as shown in FIG. 8, by fastening a pressing plate 37 against the cutting tool holder 22 by using bolts 38. The cutting tool 36, as shown in the front view of FIG. 7, has a cutting edge provided at its distal end. The cutting edge is of a substantially V-shape corresponding to a shape of each fine groove 13A to be formed in a work by the blade, as shown in FIGS. 9(A) and 9(B). The slight movement of the cross joint 30 due to rotation of the adjusting screws 33, 34 moves the cutting tool holder 22 together with the cross joint 30 in a direction orthogonal to the axial center of the spindle 20, thereby providing fine adjustment in positioning. Consequently, the position of the apex 36A of the cutting edge of the cutting tool 36 can be made consistent with the axis of the spindle 20. Thus, the position of the apex 36A of the cutting edge of the cutting tool 36 can be securely set on the axial center of the spindle 20. As shown in FIG. 8, the cutting tool 36 has the rake angle α (in some cases, this angle is a negative value or zero) and the clearance angle β. When the cutting edge of the cutting tool 36 is oriented in a direction as shown in FIG. 8, the cutting tool 36 can provide a cutting process to the work by moving the work from right to left in the drawing, while the cutting tool 36 can not perform the cutting process for the work if the work is moved from left to right in FIG. 8.

Next, the cutting process in the case of providing the center adjusting means as described above to the cutting tool turn table 19 will be discussed.

A machining process is performed by reciprocating the table 11 in the X axial direction at a predetermined speed suitable for cutting due to the cutting tool 36. As with the first embodiment, the stroke, in which the table 11 is moved from the left end position of the bed 10 as shown in FIG. 9(A) to the right end position of the bed 10 as shown in FIG. 9(B), is defined as the advancing stroke. On the other hand, the stroke to be performed in the reverse direction is defined as the retracting stroke.

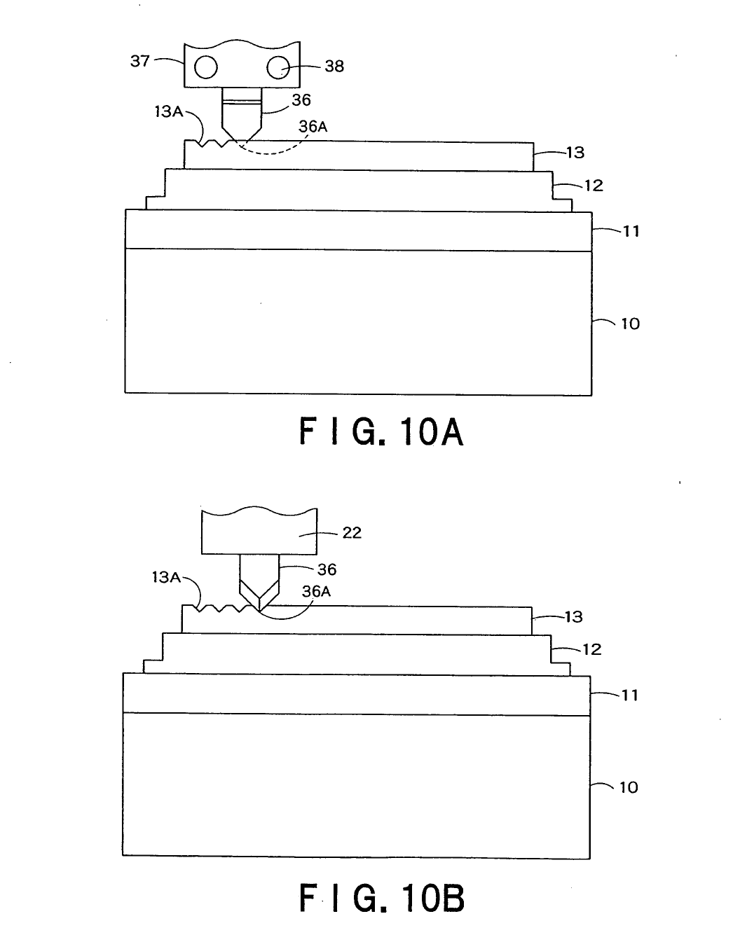

Upon the advancing stroke, the cutting tool 36 is set such that the cutting edge will face left as shown in FIG. 9(A). With the so-set cutting tool 36, the fine groove 13A is formed in the surface of the work 13 which is moved left to right in FIG. 9(A). FIG. 10(A) is a front view when a key portion shown in FIG. 9(A) is seen from the left side. To express the shape of each formed groove 13A, FIG. 10(A) shows a state just prior to start of machining in a second advancing stroke, rather than in a first advancing stroke.

Once the work 13 reaches the right end of the bed 10, as shown in FIG. 9(B), the cutting process in the advancing stroke is ended. When the work 13 is spaced, rightward, away from the cutting tool 36, as shown in FIG. 9(B), the saddle 16 is moved in the Y axial direction along the cross rail 15. Namely, as shown in FIG. 10(B), the cutting tool 36 is shifted, rightward, in the drawing, by a distance corresponding to one pitch of each groove 13A previously formed.

At the same time the cutting tool 36 is moved in the Y axial direction, the spindle 20 is driven to be turned 180° by the servomotor 21 of the C axis. Consequently, as shown in FIGS. 9(B) and 10(B), the cutting edge of the cutting tool 36 is turned to take the reverse orientation. At this time, the cutting tool 36 is only turned, with its position in the Z axial direction being not shifted. Therefore, the level of the apex 36A of the cutting edge 36 is not changed but maintained constant.

In addition, the apex 36A of the cutting edge of the cutting tool 36 is positioned on the axial center of the spindle 20, as described above, by adjusting, in advance, the position of the cross joint 30 by using the adjusting screws 33, 34. Therefore, no positional shift in the Y axial direction of the apex 36A associated with the turning to the reverse orientation will occur. Accordingly, the cutting edge of the cutting tool 36 can be accurately located in a next machining position for forming a next groove, i.e., a next machining position that the cutting edge will reach after being moved by one pitch in the Y axial direction.

After the turning to the reverse orientation of the cutting edge of the cutting tool 36 as described above, the table 11 is moved from the right end position of the bed 10 as shown in FIG. 9(B) to the left end position of the bed 10 as shown in FIG. 9(A). During this retracting stroke, the cutting process is provided to the next groove 13A.

Once the cutting process is ended through the above retracting stroke, the orientation of the cutting edge of the cutting tool 36 is again reversed to take the position shown in FIG. 9(A), so as to perform a next advancing stroke. In this manner, the same retracting and advancing strokes for machining the work will be repeated successively.

In the second embodiment discussed above, one example in which the cross joint 30 was employed as the center adjusting means for accurately positioning the cutting tool 36 on the axial center of the spindle (C axis) 20 has been discussed. The embodiment is not limited to this aspect and may employ various other suitable center adjusting means.

Furthermore, in this embodiment, one example in which the machining process is performed in both of the advancing and retracting strokes due to the turning to the reverse orientation of the cutting tool 36 has been described, this invention is not limited to this aspect. Namely, this invention can also be applied to the case in which the cutting process is performed such that the cutting tool 36 will describe a predetermined curve while changing its cutting orientation, in at least either one of the advancing and retracting strokes.

### Third Embodiment

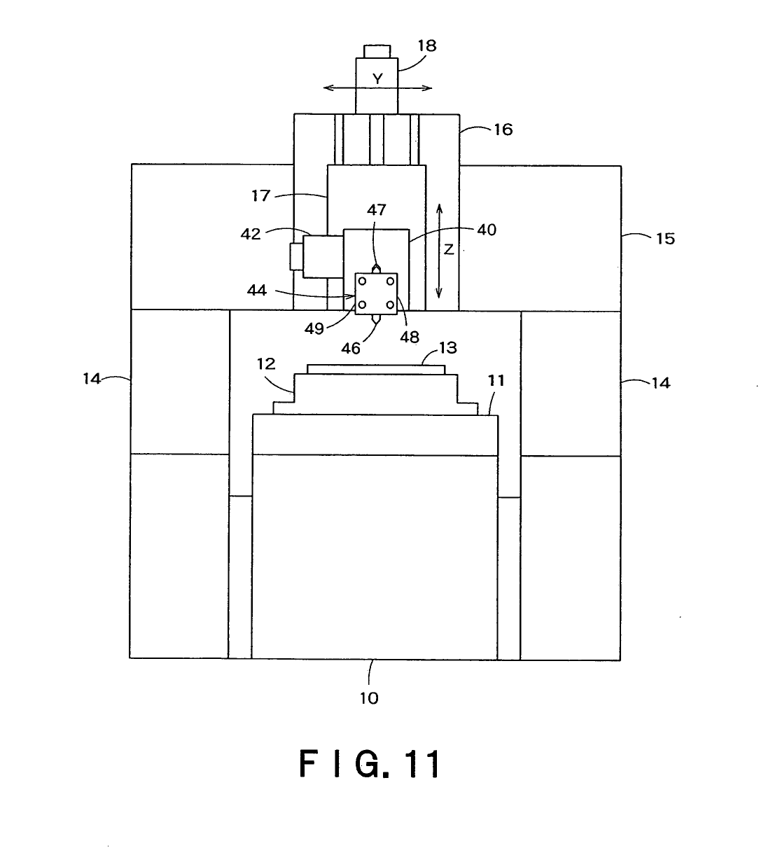

Next, a third embodiment of the present invention will be described with reference to FIGS. 11 to 16. It should be noted that the construction of a main body of the planer type machining tool to which this invention is applied is similar to that of the first embodiment shown in FIG. 1. Therefore, like parts will be designated by like reference numerals and will not be further detailed below.

The third embodiment has a feature that a cutting tool index head as will be described below is provided in place of the cutting tool turn table 19 employed in the first embodiment.

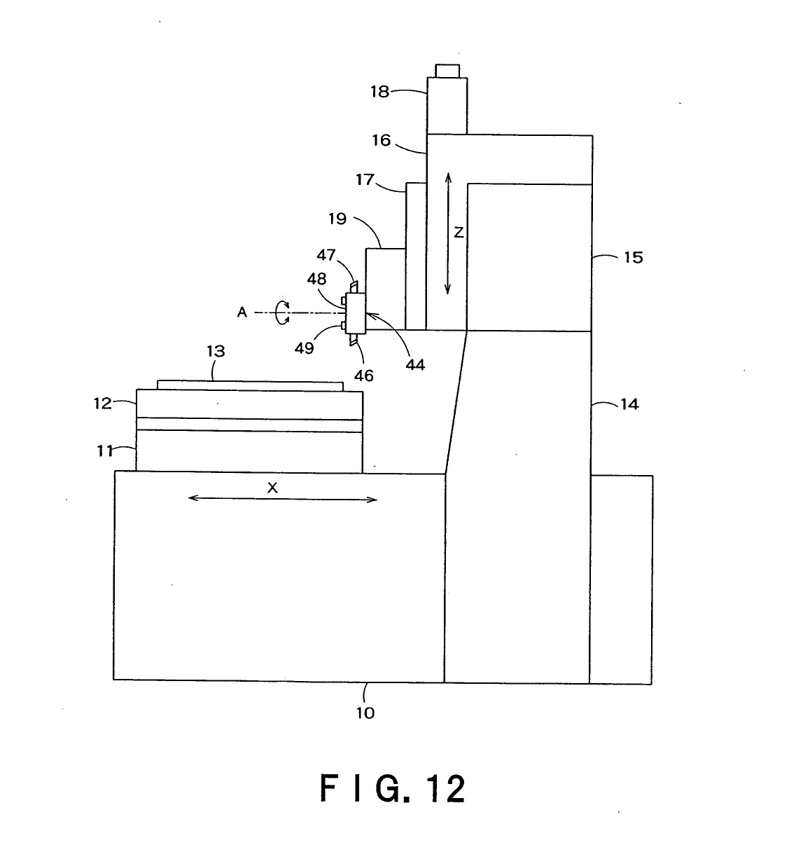

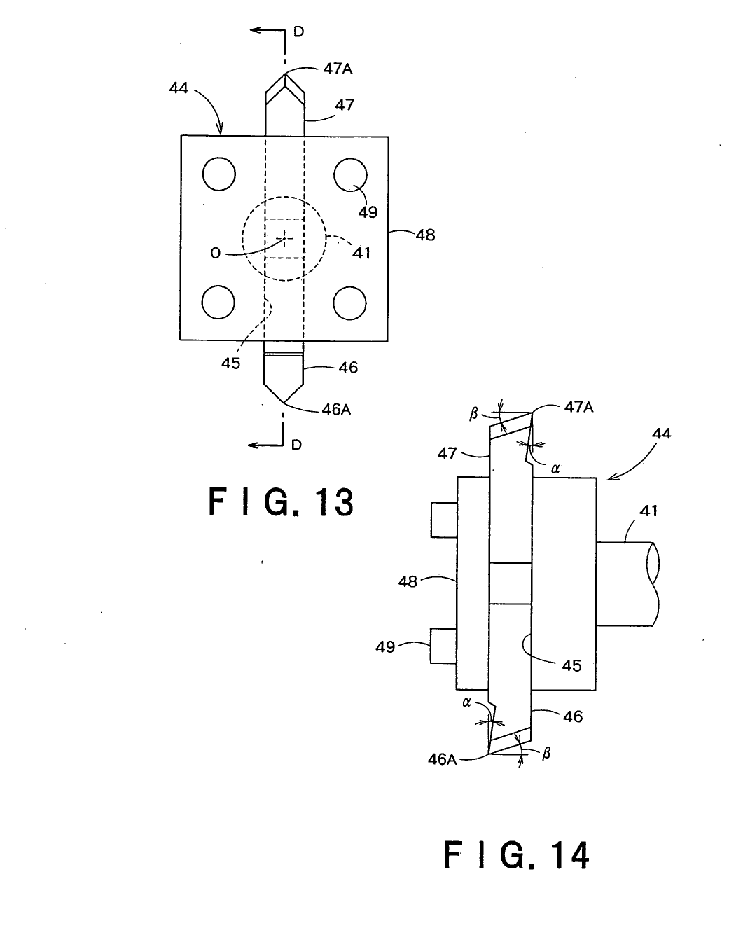

In FIGS. 11 and 12, a cutting tool index table 40 is attached to the lifting table 17. To the cutting tool index table 40, a rotation shaft (A axis) 41 extending in parallel to the X axis is rotatably attached (see FIGS. 13 and 14). The rotation shaft 41 is given a 180° rotation by a servomotor 21 attached to the cutting tool index head 40. The A axis serves to control the index operation for the rotation shaft 41.

At a distal end of the rotation shaft 41, a cutting tool holder 44, which is shown as enlarged in FIGS. 13 and 14, is attached. The cutting tool holder 44 includes a groove 45 extending vertically and orthogonally to the axis of the rotation shaft 41. In the groove 45, two cutting tools 46, 47 are fitted, with their cutting edges being oriented upward and downward, in the drawings, respectively. Both of the cutting tools 46, 47 are fixed by fastening a pressing plate 48 against the cutting tool holder 44 by using bolts 49.

The cutting tool 46 downwardly positioned in FIGS. 13 and 14 has the rake angle α (in some cases, this angle is a negative value or zero) and the clearance angle β, as shown in FIG. 14. This cutting tool 46 can provide a cutting process to the work when moving the work from right to left in FIG. 14. On the other hand, the cutting tool 47 located in the upper position in FIGS. 13 and 14 has the rake angle α and clearance angle β both oriented in the reverse directions to those angles of the cutting tool 46, respectively, as shown in FIG. 14. Accordingly, this cutting tool 47 can provide a cutting process to the work when moving the work from left to right in FIG. 14.

The cutting tools 46, 47 are attached to the cutting tool holder 44, such that these cutting tools are in a symmetrical relation to each other with a 180° angular interval with respect to the axis O of the rotation shaft 41. For each 180° rotation upon indexing the rotation shaft 41, the positions of the cutting tools 46, 47 are switched to each other in a plane parallel with the Y-Z plane, as such being located interchangeably to take the lower machining position.

Next, a machining method according to the third embodiment as described above will be discussed.

First, the position in the Z axial direction of the cutting tool 46 taking in the lower machining position is adjusted to match the depth of each fine groove 13A to be formed. This is for setting a cutting amount of the cutting tool 46. Thereafter, by moving the lifting table 17, as shown in FIGS. 11 and 12, due to the servomotor 42, the level of the table 17 is determined, corresponding to the cutting amount of the cutting tool 46. In addition, the position in the Y axial direction of the saddle 16 is adjusted or controlled by the driving apparatus (not shown), such that the cutting tool 46 is located to match a machining position of the fine groove 13A to be formed first.

Subsequently, the table 11 is reciprocated, in the X axial direction, at a predetermined feed speed suitable for the cutting operation due to the cutting tool 46, so as to perform the cutting process.

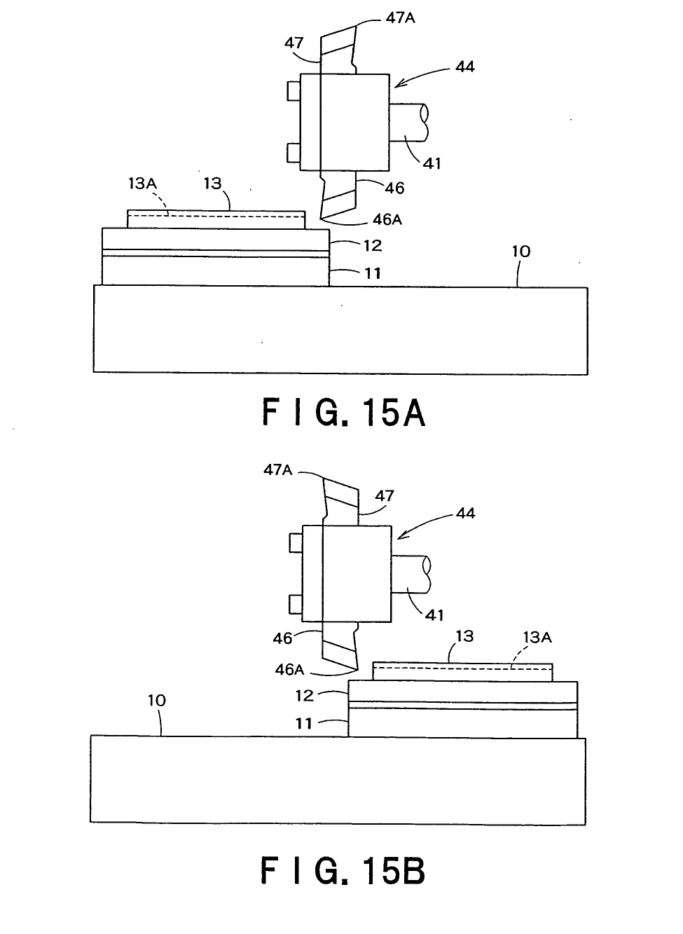

A stroke, in which the table 11 is moved from a left end position of the bed 10 as shown in FIG. 15(A) to a right end position of the bed 10 as shown in FIG. 15(B), is defined herein as the advancing stroke. On the other hand, a stroke, in which the table 11 is moved from the right end position of the bed 10 shown in FIG. 15(B) to the left end position of the bed 10 shown in FIG. 15(A), is defined as the retracting stroke.

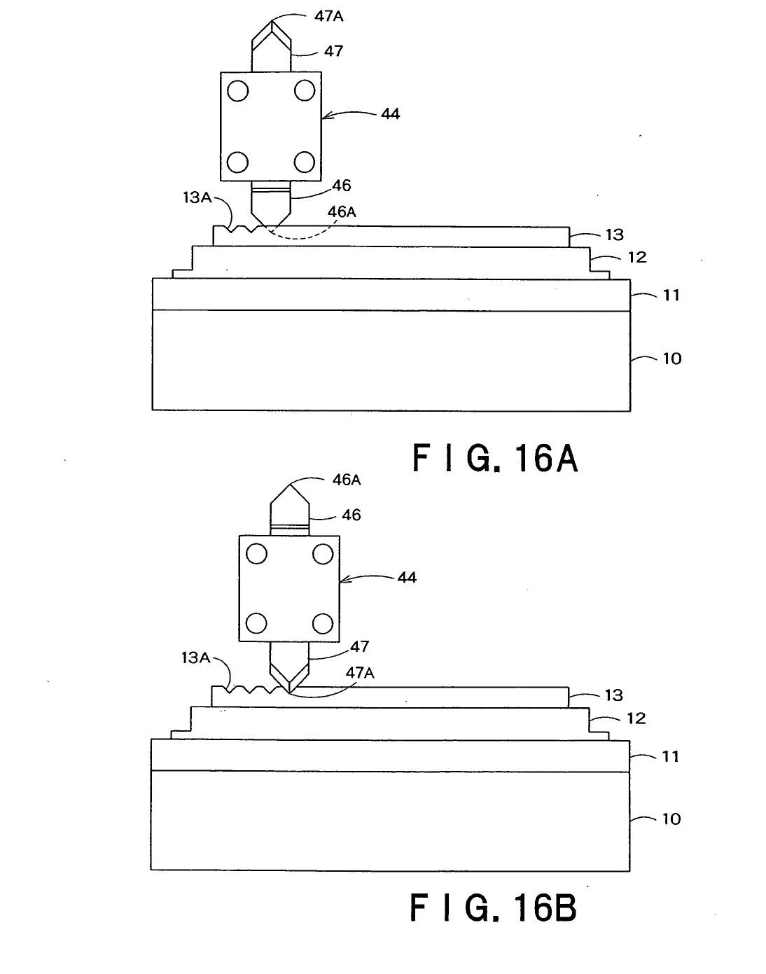

Upon the advancing stroke, the cutting tool 46 is set such that it is located in the lower machining position as shown in FIG. 15(A). With the so-set cutting tool 46, the fine grooves 13A are formed in the surface of the work 13 which is moved left to right in FIG. 15(A). FIG. 16(A) is a front view when a key portion shown in FIG. 15(A) is seen from the left side. To clearly express the shape of each formed groove 13A, FIG. 16(A) shows a state just prior to start of machining in a second advancing stroke, rather than in a first advancing stroke.

Once the work 13 reaches the right end of the bed 10, as shown in FIG. 15(B), the cutting process in the advancing stroke is ended. When the work 13 is spaced, rightward, away from the cutting tool 46, as shown in FIG. 15(B), the saddle 16 is moved in the Y axial direction along the cross rail 15. Namely, as shown in FIG. 16(B), the cutting tool holder 44 is shifted, rightward, in the drawing, by a distance corresponding to one pitch of each groove 13A previously formed.

At the same time the cutting tool holder 44 is moved in the Y axial direction, the rotary shaft 41 is driven to be turned 180° by the A axis servomotor 42. Consequently, as shown in FIGS. 15(A) and 16(B), the cutting tool holder 44 is turned in the Y-Z plane, as such the cutting tool 47 having been positioned upward can be indexed to take the lower machining position. At this time, as shown in FIG. 13, since the cutting edges 46A, 47A of the cutting tools 46, 47 are in a symmetrical relation to each other with respect to the axis O of the rotation shaft 41. The cutting tool 47 replaces the cutting tool 46 having taken the lower machining position as shown in FIG. 16(A), thus reversing the cutting direction. In this case, the cutting tool 47 is accurately located or set in a next machining position shifted, by one pitch in the Y axial direction, from the position in which the cutting tool 46 has been located before the replacement.

Associated with the positional change of the cutting tools 46, 47 described above, if some positional shift in the Y axial direction and/or Z axial direction would also occur between the cutting tools 46, 47, such a shifting amount should be measured in advance for each replacement. Consequently, the transfer amount of the saddle 16 in the Y axial direction can be corrected, as well as the transfer amount of the lifting table 17 in the Z axial direction can be adjusted, optionally, corresponding to the shifting amount. In this way, any undue shift relative to a desired machining position for the cutting tool 47 associated with the cutting tool replacement can be controlled.

Once the cutting tool 47 is set in the lower machining position as described above, the table 11 is moved from the right end position of the bed 10 as shown in FIG. 15(B) to the left end position of the bed 10 as shown in FIG. 15(A), thus cutting the next groove 13(A) during this retracting stroke.

Once completing the cutting process in the aforementioned retracting stroke, the cutting tool holder 42 is rotated reversely, and the cutting tool 46 having been positioned upward is indexed to return again to the lower machining position, so as to machine the work in a next advancing stroke. Thereafter, the same machining is repeated, in each retracting and advancing stroke, successively.

As stated above, by the indexing operation for each cutting tool 46, 47, the machining in both of the advancing and retracting directions for the work can be performed, thus reducing the machining time approximately by half.

In the third embodiment described above, one example, in which the work 13 is reciprocated relative to the cutting tools 46, 47 by utilizing the planer type machining tool, has been described. This invention, however, is not limited to this aspect. For instance, the work 13 may be fixed while the cutting tools 46, 47 may be reciprocated. Additionally, the application of this invention is not limited to the mold for producing parts each having a fine structure, such as light guide plates and shielding sheets to be used for liquid crystal panels, but may also be applied to machining other various types of works. Furthermore, the shape to be formed by the aforementioned machining is not limited to the groove, but may also be a flat face to be obtained by machining due to a flat cutting tool. Additionally, three or more cutting tools may be provided so as to use them under optional selection and indexing. Namely, it should be appreciated that various modifications not described and illustrated herein can also be made without departing from the scope of this invention.

1. A method for machining a surface of a work with a cutting tool, by utilizing an reciprocating movement consisting of an advancing stroke for relative movement in one direction and a retracting stroke for relative movement in the reverse direction to the advancing stroke, in the same plane, between the cutting tool and the work, the method comprising the steps of:
providing a machining tool including a spindle having an axis vertical to the plane, as a center of rotation, and attaching the cutting tool to the spindle;
setting the orientation of a cutting edge of the cutting tool in a direction that enables the work to be machined in an advancing stroke, in which the work is advanced relative to the cutting tool;
machining the work, in the advancing stroke, by using the cutting tool;
turning the cutting tool reversely, by 180°, upon completion of the advancing stroke, so as to set the orientation of the cutting edge of the cutting tool in a direction that enables the work to be machined in a retracting stroke, in which the work is retracted relative to the cutting tool;
shifting the cutting tool in a direction vertical to the reciprocating directions of the work so as to locate the cutting tool in a next machining position; and
machining the work by using the cutting tool in the retracting stroke.

2. The method according to claim 1, wherein the cutting tool is located such that a distal end of the cutting edge is positioned on the axial center of the spindle.

3. The method according to claim 1, wherein a shifting amount between the distal end of the cutting edge of the cutting tool and the axial center of the spindle is measured in advance, and the transfer amount of the work, when the cutting tool is moved to a next machining position, is corrected, corresponding to the shifting amount.

4. The method according to claim 3, wherein a distal end of the cutting edge of the cutting tool is of a substantially V-shape corresponding to a groove to be formed in the surface of the work due to the machining by using the cutting edge, and an apex of the cutting edge is positioned on the axial center of the spindle.

5. A method for machining a surface of a work with a cutting tool, by utilizing an reciprocating movement consisting of an advancing movement stroke for relative movement in one direction and a retracting stroke for relative movement in the reverse direction to the advancing movement, in the same plane, between the cutting tool and the work, the method comprising the steps of:
providing a machining tool having an index head, the index head including a rotation shaft having an axis parallel to the plane, as a center of rotation, and adapted to index at least two cutting tools, one after another, by utilizing the rotation of the rotation shaft, and attaching the at least two cutting tools to the index head, the at least two cutting tools being in a relation to have reverse directions, to one another, for cutting operation, so that the work can be machined in both of the advancing and retracting strokes for the work;
indexing one cutting tool of the plurality of cutting tools to take a machining position by utilizing the rotation of the rotation shaft, so as to cause a cutting edge of the one cutting tool to be oriented in a direction that enables the work to be machined in an advancing stroke, in which the work is advanced relative to the one cutting tool;
machining the surface of the work, in the advancing stroke, by using the one cutting tool having been indexed in the machining position;
indexing the other cutting tool to take a machining position by utilizing the rotation of the rotation shaft, upon completion of the advancing stroke, so as to cause a cutting edge of the other cutting tool to be oriented in a direction that enables the work to be machined in a retracting stroke, in which the work is retracted relative to the other cutting tool;
shifting the other cutting tool in a direction vertical to the reciprocating directions of the work so as to locate the other cutting tool in a next machining position; and
machining the surface of the work, in the retracting stroke, by using the other cutting tool having been indexed in the next machining position.

6. The method according to claim 5, wherein a shifting amount of each cutting tool associated with replacement of the cutting tools upon changing the strokes between the advancing stroke and the retracting stroke is measured in advance, and the transfer amount of the work, when the cutting tool is moved to a next machining position, is corrected, corresponding to the shifting amount.

7. The method according to claim 6, wherein a distal end of the cutting edge of each cutting tool is of a substantially V-shape corresponding to a groove to be formed in the surface of the work due to the machining by using the cutting edge, and an apex of the cutting edge is positioned on the center of rotation of the rotation shaft.

8. The method according to claim 1, wherein the cutting tool can cut the work along a predetermined curved route while changing the orientation of the cutting edge during the advancing or retracting stroke.

9. The method according to claim 1, wherein a plurality of fine grooves are formed in the surface of the work by the cutting operation, with a predetermined pitch, in parallel to each other.

10. The method according to claim 1, wherein the work is a mold for molding a light guide plate, a diffusion plate and a shielding sheet, for use in a liquid crystal panel.

11. An apparatus for machining a surface of a work, while reciprocating the work on a plane relative to a cutting tool, the apparatus comprising:
a bed;
a work table, which is located on the bed, configured to be optionally moved, on a horizontal plane, in one direction (X axis), and adapted for placing the work thereon;
a pair of columns positioned on both of the left and right sides of the bed;
a cross rail provided across the columns;
a saddle, which is mounted on the cross rail, and configured to be optionally moved, on the horizontal plane, in a direction (Y axis) vertical to the transfer direction of the work table;
a lifting table, which is mounted on the saddle, and configured to be optionally moved in the upward and downward directions (Z axis); and
a cutting tool turn table, which is attached to the lifting table, and includes a C axis adapted for turning a cutting edge of the cutting tool about the Z axis to reverse the orientation of the cutting edge, while holding the cutting tool.

12. The apparatus according to claim 11, wherein a control axis adapted for reciprocating the work table is defined as the X axis, a control axis adapted for moving the saddle so as to transfer the cutting tool in a machining position is defined as the Y axis, and a control axis adapted for transferring the lifting table so as to determine a cutting amount of the cutting tool is defined as the Z axis.

13. The apparatus according to claim 11, wherein the cutting tool turn table includes:
a spindle extending in parallel to the Z axis and configured to be turned based on the C axis as a control axis;
a servomotor adapted to turn the spindle; and
a cutting tool holder attached to a distal end of the spindle and adapted to hold the cutting tool.

14. The apparatus according to claim 13, wherein the cutting tool is held by the cutting tool holder, such that a distal end of the cutting edge is positioned on the axial center of the spindle.

15. The apparatus according to claim 11, wherein the cutting tool turn table includes:
a spindle extending in parallel to the Z axis and configured to be turned based on the C axis as a control axis;
a servomotor adapted to turn the rotation shaft;
a cutting tool holder attached to a distal end of the rotation shaft and adapted to hold the cutting tool; and
a center adjusting means provided between the cutting tool holder and the rotation shaft and adapted to adjust a distal end of the cutting edge of the cutting tool to be positioned on the axial center of the spindle.

16. The apparatus according to claim 15, wherein the center adjusting means comprises a cross joint including projections, which are respectively engaged with a groove formed in an end face of the rotation shaft and a groove formed in an end face of the cutting tool holder, while extending orthogonal to each other, and a means for finely adjusting the position of the cross joint as well as the position of the cutting tool holder, along the respective directions of the projections.

17. An apparatus for machining a surface of a work, while reciprocating the work on a plane relative to a cutting tool, the apparatus comprising:
a bed;
a work table, which is located on the bed, configured to be optionally moved, on a horizontal plane, in one direction (X axis), and adapted for placing the work thereon;
a pair of columns positioned on both of the left and right sides of the bed;
a cross rail provided across the columns;
a saddle, which is mounted on the cross rail, and configured to be optionally moved, on the horizontal plane, in a direction (Y axis) vertical to the transfer direction of the work table;
a lifting table, which is mounted on the saddle, and configured to be optionally moved in the upward and downward directions (Z axis); and
a cutting tool indexing table attached to the lifting table and adapted to hold at least two cutting tools, the at least two cutting tools being in a relation to have reverse directions for cutting, wherein the cutting tool indexing table includes an A axis adapted to index two cutting tools, one after another, such that the work can be machined in both of advancing and retracting strokes for the work.

18. The apparatus according to claim 17, wherein a control axis adapted for reciprocating the work table is defined as the X axis, a control axis adapted for moving the saddle so as to transfer the cutting tool in a machining position is defined as the Y axis, and a control axis adapted for transferring the lifting table so as to determine a cutting amount of the cutting tool is defined as the Z axis.

19. The apparatus according to claim 17, wherein the cutting tool turn table includes:
a rotation shaft extending in parallel to the X axis and configured to be turned based on the A axis as a control axis;
a servomotor adapted to turn the rotation shaft;
a cutting tool holder attached to a distal end of the rotation shaft and includes grooves formed therein to be symmetrical with respect to the center of the rotation shaft, wherein the cutting tools are respectively fitted in the grooves; and
a pressing plate for fixing the cutting tools respectively fitted in the grooves.

20. The apparatus according to claim 19, wherein the two cutting tools are held in the cutting tool holder, such that distal ends of the cutting edges of the two cutting tools are respectively positioned to be symmetrical with respect to the axial center of the rotation shaft.
